(19) United States
(12) Patent Application Publication
(10) Pub. No.: US 2006/0084024 A1
(43) Pub. Date: Apr. 20, 2006

(54) Oral appliance

(76) Inventor: Christopher John Farrell, Helensvale (AU)

Correspondence Address: Thomas E. Kocovsky, Jr.;FAY, SHARPE, FAGAN, MINNICH & McKEE, LLP, Seventh Floor, 1100 Superior Avenue, Cleveland, OH, 44114-2579, US

(21) Appl. No.: 11/250,279

(22) Filed: Oct. 14, 2005

Related U.S. Application Data
(60) Provisional application No. 60/618,691, filed on Oct. 14, 2004.

(51) Int. Cl. A61C 3/00

(52) U.S. Cl. 433/6; 128/861

(57) ABSTRACT

An orthodontic trainer 1 for assisting the correction of the misalignment of teeth is disclosed. The trainer 1 comprises a base member 2 made of nylon having a generally U-shaped form corresponding to the outline of the jaw of a user and a teeth engaging member 5 that encases the base member 2. The base member 2 has an open frame structure with curved inner and outer elongate frame members 12, 10 interconnected at spaced intervals by transverse frame members 15. The trainer 1 includes a outer teeth repositioning formation in the form of an outer flange is positioned on the outer elongate frame member 10. The trainer 1 also includes an inner teeth repositioning formation on the inner elongate frame member 12. The continuous teething engaging member 5 that is made of silicone rubber or PVC comprises a web 40 and inner and outer flanges 44, 45 projecting up and down from both upper and lower faces of the web 40. These flanges 44, 45 and the web 40 define upper and lower channels within which the upper and lower teeth of the user can be received. The trainer 1 also includes teeth positioning formations on the teeth engaging member 5 projecting into the upper and lower channels for encouraging the correct positioning of the teeth of a user.

### FIELD OF THE INVENTION

This invention relates to an oral appliance.

This invention relates particularly but not exclusively to an oral appliance that is an orthodontic appliance used to assist in correcting the misalignment of teeth by applying a correcting force to the teeth. It will therefore be convenient to hereinafter describe this invention in detail with reference to this example application. However it is to be clearly understood that the invention is capable of broader application. For example the invention might be applied to appliances that encourage an improvement in oral habits such as tongue thrusting without applying a repositioning force to the teeth.

Finally the appliance could also be used as a mouth guard or sports guard as well.

### DEFINITIONS

In this specification the term engaging shall bear a broad meaning and shall not be limited to mean retaining or latching engagement.

### BACKGROUND TO THE INVENTION

Various types of orthodontic appliances are known. One such type of orthodontic appliance is custom made after taking impressions of a patient's mouth. The impressions are used to make moulds which in turn are used to make an appliance that is specifically dimensioned and configured to suit that patient's mouth. Not surprising these appliances fit snugly into a user's mouth and are efficacious in operation. However the limitation of custom made appliances is the high cost of producing such an appliance and this has reduced their uptake in the market place.

There is therefore a clear need for an appliance that can be manufactured in large quantities in a manufacturing process and that can also be fitted to fit a variety of patient's mouths with a comfortable and snug fit.

One mass produced orthodontic trainer is produced by Myofunctional Research Pty Ltd, of Helensvale Plaza, Sir John Overall Drive, Helensvale, in the state of Queensland, Australia.

The trainer has a shape resembling that of an arch and defines upper and lower channels for receiving respectively the teeth of the upper and lower arches of a user.

The trainer is made of silicone rubber and is moulded in a single moulding operation. Thus the silicon rubber has a single homogeneous form and consistency throughout the appliance and is generally soft and flexible. The walls of the trainer that define channels for the upper and lower teeth are soft and therefore comfortable against the teeth and gums of a user. However because the trainer is soft it does not apply a strong retaining and correcting force to teeth that are received within the channels. For example it is easy to bend and twist the member.

The trainer described above has been used to try and improve the oral habits of users, in particular children. The tongue tab assists in correctly positioning the tongue and reducing tongue thrusting. It also correctly positions the lower jaw with respect to the upper jaw.

The trainer has also been used to try and improve the alignment of teeth and has been found to have some positive influence on correcting the misalignment of teeth. However there is still room for considerable improvement in this regard. The softness of the silicone rubber material that abuts the teeth really limits the ability of the trainer to reposition a user's teeth.

One possibility would appear to be to make the trainer from a material that was harder than silicone rubber such as polyurethane. However the polyurethane would be hard against the soft gums of the user and cause pain and discomfort. In addition if the appliance was made of a single hard material it would have limited ability to bend and deform to receive misaligned teeth. It would thus be harder to fit to a wide number of users all with their own individual arch sizes and teeth alignments. Thus there would be difficulties in fitting the trainer in the first place.

While it is evident that there is no simple solution to this problem clearly it would be extremely useful if a trainer could be devised that was soft and comfortable to wear and which also generated a strong repositioning force. This would achieve the benefits of the prior art silicone rubber trainer while also exerting a stronger influence on the realignment of a user's teeth. Such a trainer would provide a great step or leap forward in the art of orthodontic trainers.

### SUMMARY OF THE INVENTION

According to one aspect of this invention there is provided an oral appliance, comprising:

a base member having a generally U-shaped form corresponding to the outline of the jaw of a user, the base member being made of a material; and

a continuous teething engaging member made of another material that is softer than the material of the base member that encloses and encases at least part of the base member and defines at least one of upper and lower teeth channels within which the associated arch and teeth of the user can be received.

The oral appliance may be an orthodontic trainer for assisting in maintaining the user's teeth in a desired position and/or promoting movement of the teeth into a more desirable position.

The oral appliance may be a sports guard or a mouthguard for providing protection for a user's teeth when playing sports such as contact sports and the like.

The teeth engaging member may be made of a polymeric material.

The polymeric material may be a polymeric material containing silicon as a repeating unit within the polymer. This may be a synthetic elastomer which is a cross linked polymer reinforced with silica.

The polymeric material may be a siloxane polymer or a silane polymer. In one form of the invention the polymer containing silicon is silicone rubber, e.g. medical grade silicone which has already found acceptance in the field of orthodontic trainers. The silicone material will be particularly soft and comfortable against the gums and other mouth tissues of a user. It has some ability to deform and bend around the teeth and gums.

Alternatively the polymeric material of the teeth engaging member may be an addition polymer. The addition polymer may be polyvinylchloride (PVC). Polyvinyl chloride has a melting point that is lower than that for silicone. As a result the temperature to which the base member is exposed to when the teeth engaging member is moulded onto it is lower when polyvinyl chloride is used for the teeth engaging member than when silicone rubber is used.

The base member may be made of a polymeric material. The polymeric material of the base member may be resilient.

The polymeric material from which the teeth engaging member is formed may be categorised as a hard material. The material from which the base member is made is characterised by the fact that it does not deform easily when local pressure or point pressure is applied to the base member. However at the same time it is capable of some bending when opposing sides of the member are twisted or pulled towards and away from each other.

The base member may also be regarded as being stiff and resist being deformed when a force is applied thereto. The resilience causes it to return to its original shape when the force is removed.

Further the polymeric material from which the base member is made may have thermoplastic properties. However the material may maintain its form and not soften when it is exposed to flowing material at a temperature of 160 degrees Celsius or below. In some embodiments it may maintain its form and not soften when exposed to material at a temperature of up to 300° C.

The polymeric material from which the base member is made may be a polyamide material. The polyamide material may be formed either by a condensation polymerisation of amide monomers or a ring opening polymerisation of caprolactam.

The polyamide material may be a polyamide polymer commonly known as nylon or sold under the trade mark NYLON which is the trade mark of the Du Pont Chemical company, Wilmington, Del., U.S.A.

The polyamide material, e.g. nylon, is particularly suitable because it has a suitable balance between resilience, and stiffness. It does permit some flexing of the arms of the base member. However it has a good memory when subjected to bending or twisting forces and tends to return to its original form when the forces are removed. This helps the base member to maintain the desired arch while still maintaining a reasonable degree of wearer comfort.

Alternatively the polymeric material of the base member may be an addition polymer or a condensation polymer. The addition polymer may include polyethylene or polypropylene. The condensation polymer may include polyurethane or polycarbonate. The polymeric material may also include a thermoplastic elastomer such as santoprene.

In one embodiment of the invention practised by the Application the base member is made of polyamide material and the teeth engaging member is made of silicone rubber.

With this combination the polyamide, e.g. nylon, base member is moulded first during the manufacture of the trainer. Thereafter the silicone teeth engaging member is moulded onto the base member. The nylon base member has the property that it does not soften and melt when it is exposed to molten silicone rubber when the silicone rubber is injected into the mould and encases the base member.

Thus the oral appliance essentially comprises a base member that is formed from a material that provides an underlying skeletal strength to the appliance, and an encasing teeth engaging member of silicone rubber or PVC that Is considerably softer and more formable than the base member. By having a rigid underlying base member the appliance is able to exert a considerably stronger influence on the alignment of a patient's teeth than if the appliance were made solely of soft silicone rubber. In addition it is able to preserve the general shape and the width of the arch.

The base member may be designed with a wide arch in which case the trainer will tend to force the teeth out into a wide arch position. This way the trainer can be used to expand narrow arches into more aesthetically pleasing and desirable wide arches.

The base member may be in the form of an open frame structure, eg a flat open frame structure, with curved inner and outer longitudinal frame members that are interconnected at spaced intervals by transverse frame members. The open frame structure may lie broadly in a plane. That is the longitudinal frame members and the transverse frame members may all lie broadly in the same plane. The plane may extend in a substantially horizontally extending direction.

The base member may further include an outer teeth repositioning formation on the outer longitudinal frame member.

The outer teeth repositioning formation may comprise an outer flange projecting up from the outer frame member above the height of the transverse frame members and/or depending down from the outer frame member below the level of the transverse frame members.

The base member may further include an inner teeth repositioning formation on the inner longitudinal frame member.

The inner teeth repositioning formation may comprise an inner flange projecting up from the inner frame member above the height of the transverse frame members and/or depending down from the inner frame member below the level of the transverse frame members.

The base member may have a central front region and left and right arm regions extending rearward from the central front region to left and right rear ends.

The outer flange may project upwardly from the transverse frame members along at least said central front region. Thus in use the outer flange extends over and across the upper front teeth of a user.

The central front region of the outer flange, may extend upwardly above the transverse frame members, e.g. an upper surface of the transverse frame members, by 2-10 mm, e.g. 4-8 mm, e.g. about 6 mm. The central front region of the outer flange may also extend above the plane of the open frame by 2-10 mm, e.g. 4-8 mm, e.g. about 6 mm. Thus the outer flange may have some height, particularly in the central front region.

The outer flange may also project upwardly above the transverse frame members along left and right arm regions of the base member.

The left and right arm regions of the outer flange may extend upwardly above the transverse frame members, e.g. an upper surface of the transverse frame members, by 2-6 mm, e.g. 3-5 mm, e.g. about 4 mm. The left and right arm regions of the outer flange may also extend upwardly above the plane of the open frame by 2-6 mm, e.g. 3-5 mm, e.g. about 4 mm. Thus the outer flange in the central front region is higher than the flange on the left and right arm regions, e.g. which extends over at least part of the molars of the user.

Further the outer flange may be interrupted, or be of reduced height, at positions on the left and right hand sides intermediate the left and right arm regions of the outer flange and the central front region of the outer flange. These positions on the left and right sides correspond to the canine teeth. The height of the outer flange is reduced at these points because the canine teeth sometimes project out relative to the other teeth and may not fit behind the flange if the outer flange was the same height as it is in the central front region.

The outer flange may be formed integrally with the curved outer longitudinal frame member, e.g. in an injection moulding operation.

The inner flange on the curved inner longitudinal frame member may extend a distance of about 1-3 mm, e.g. about 2 mm up from the transverse frame members, e.g. the upper surface of the transverse frame members. The inner flange on the curved inner longitudinal frame member may extend a distance of about 1-3 mm, e.g. about 2 mm up from the plane of the open frame.

The inner flange may project up from the transverse frame members along at least the central front region of the inner longitudinal frame member. The inner flange may project up from the transverse frame members along the full length of the inner longitudinal frame member. Further the inner flange may project up to substantially the same height along its full length.

The inner flange may also be formed integrally with the curved inner element, eg in an injection moulding process.

In one form of the invention the outer flange on the curved outer longitudinal frame member does not extend or depend downwardly below the plane of the open frame to any appreciable extent. Similarly the flange on the curved inner longitudinal frame member does not extend or depend downwardly below the plane of the open frame to any appreciable extent.

However it needs to be appreciated that an appliance with one or more downwardly depending flanges is contemplated to be within the scope of the invention. Applicant has found that a satisfactory stiffness and strength can be obtained with outer and inner flanges that only project up from the open frame and not down from the open frame. However if greater strength was required near the outer longitudinal frame member, e.g. on the outside of the teeth, the flange could depend downwardly as well as projecting upwardly. A downwardly depending inner flange could also be provided.

In a further alternative the inner and outer flanges described above could also be provided projecting down from the plane of the open frame or the transverse frame members instead of projecting up from the transverse frame members.

The base member may have a front said transverse frame member in the central front region of the base member, and two rear said transverse frame members at the rear of the left and right arm regions of the base member.

The base member may also have a plurality of intermediate said transverse frame members in between the rear transverse frame members at the rear of the arm regions and the front transverse frame member.

The transverse frame members in the central front region of the base member may have a width of 5-15 mm, preferably 8-12 mm, and most preferably about 9-11 mm. The rear transverse frame members at the rear of each of the arm regions may have a width of 2-10 mm, preferably 3-8 mm, more preferably 4-6 mm. The intermediate transverse frame members may have a width of 1-4 mm, e.g. 2-3 mm.

Thus the transverse frame member disposed in the front region of the base member, eg substantially centrally, may have a greater width than the rear and intermediate frame members. These transverse frame members or cross elements perform important structural functions and strengthen the appliance in key areas such as the front and the rear of the arm regions.

The teeth engaging member may fully encase the open frame structure of the base member, e.g. including both upper and lower faces of the open frame structure, and also inner and outer sides of the open frame structure.

The teeth engaging member may comprise a central web having upper and lower surfaces that extends parallel to the plane of the open frame, and also inner and outer flanges that project transversely away from at least one of the upper and lower surfaces of the web. The inner and outer flanges and the web may form at least one teeth engaging formation defining a channel within which the teeth of a user are received.

The web and inner and outer flanges may form both upper and lower teeth engaging formations in which case the flanges of the member project away from both the upper and lower surfaces of the web. These teeth engaging formations formed by the flanges and the web define said upper and lower channels of the teeth engaging member.

The teeth engaging member extends around and over the base member and forms the body of the trainer. It defines the surfaces of the trainer that come into contact with and engage the teeth and gums of the user.

The teeth engaging member may encase the full surface of the base member, eg including an outwardly facing surface of the outer flange. The teeth engaging member may cover an outer surface of the outer flange with a relatively thin layer of material, e.g. substantially thinner than that covering an inside surface of the outer flange. This assists in holding the base member and teeth engaging member together.

The advantage of the teeth engaging member encasing the base member is that it assists in holding the teeth engaging member onto the base member. The base member and the teeth engaging member are made of different materials and the different materials need to conform and move with each other so that they do not delaminate. The encasement of the base member within the teeth engaging member assists in holding the two together and the appliance as a result is resistant to delamination in use.

The teeth engaging member may have broadly the same shape and form as that illustrated in the Applicant's earlier patent application PCT/AU99/00840 and published by WIPO as WO 00/35369. The contents of this specification are hereby incorporated into this specification by direct cross reference.

The teeth engaging member may further include one or more teeth positioning formations in at least one of the channels for assisting in positioning the individual teeth of a user, e.g. a plurality of said teeth positioning formations. The positioning formations may also assist in fitting the appliance initially.

The teeth positioning formations may be arranged in pairs, that are aligned with each other along the length of the channel or arch that project inward from the inner and outer flanges respectively.

Each teeth positioning formation may comprise a wedge shaped protrusion extending inwardly from a said flange into a said channel. Each positioning formation may be broadly shaped to be complementary to the shape of the user's teeth and may extend into the associated channel only a small distance.

The teeth positioning formations may be positioned so as to encourage the teeth to move towards so called ideal positions for these teeth within the mouth of a user.

The teeth positioning formations may collectively position at least the central front two incisors of the teeth of a user, e.g. at least the front four teeth of a user. In one form the teeth positioning formations collectively position the front four teeth of a user. In one form the teeth positioning formations collectively position the front four teeth of a user and the three teeth on each side rearward of the front four teeth of a user.

The protrusions may be integrally moulded with the teeth engaging member, e.g. by injection moulding, when the teeth engaging member is moulded onto base member.

As indicated above, in a preferred form the teeth engaging member defines both upper and lower channels for receiving the upper and lower teeth of a user. In such a trainer the teeth engaging member may have teeth positioning formations in both said upper and lower channels for positioning both the upper teeth and the lower teeth.

The orthodontic trainer may include holes passing through the teeth engaging member and base member and opening to both the outer surfaces of the teeth engaging member and the inner surface thereof.

The orthodontic trainer may also include a tongue tab for encouraging a user to correctly position their tongue.

The orthodontic trainer may also include a cutaway or recess defined thereof in the front region of the teeth engaging member, e.g. the curved inner flange, for enabling the width of the arch defined by the trainer, e.g. particularly the left and right arm regions of the teeth engaging and base member, to be adjusted. Conveniently this may be provided by the spaces on each side of the tongue tab.

The orthodontic trainer may also include a cut away on the midline of the curved outer flange, e.g. both above and below the web. This is provided so that this soft gum region does not make contact with the teeth engaging member when the trainer is worn to enhance comfort.

The appliance may also have some thickening of the web of the teeth engaging member in the left and right arm regions thereof. The thickness of the teeth engaging member may increase in a direction rearward from a central front region towards the rear of the left and right arm regions. This thickening may terminate at a point spaced forwardly of the rear of the left and right arm regions of the teeth engaging member. The teeth engaging member may then thin again from this point to the rear of the left and right arm regions.

The thickening of the teeth engaging member may resemble an inverted aerofoil, e.g. with a curved lower surface and a substantially planar upper surface, when viewed in cross section. This shape of the web region of the teeth engaging member correctly positions the teeth of the upper and lower jaw relative to each other so as to encourage relaxation of the muscles and also the TMJ.

Applicant envisages that the appliance will be made in several sizes and a suitable size of trainer selected for any given user based on the size of their teeth. Applicant envisages that the different sizes will comprise two different arch sizes and each arch size will have about six different sizes and positions of teeth locating formations. The different teeth locating formations will accommodate the different teeth sizes and teeth positions of different users.

According to another aspect of this invention there is provided an orthodontic trainer, comprising:
a base member made of a polyamide material having a generally U-shaped form corresponding to the outline of the jaw of a user, the base member having an open frame structure with curved inner and outer elongate frame members interconnected at spaced intervals by transverse frame members, the base member having a central front region and left and right arm regions, and the base member including a teeth repositioning formation on the outer elongate frame member that extends across at least the front central region; and
a continuous teething engaging member made of a polymeric material that is a silicone rubber or polyvinyl chloride (PVC) that encloses and encases the base member and comprises a web and inner and outer flanges projecting up and down from both upper and lower faces of the web and defining upper and lower channels within which the upper and lower teeth of the user can be received.

The teeth repositioning formation on the outer elongate frame member may also extend across at least part of the left and right arm regions as well as said central front region. The base member may include a further teeth repositioning formation on the inner elongate frame member.

The orthodontic trainer may further include teeth positioning formations for encouraging the correct positioning of the teeth of a user.

The base member may be made of a polyamide material that is nylon. The teeth engaging member may be made of silicone rubber.

According to yet another aspect of this invention there is provided a sports guard, comprising:

a base member made of a polyamide material having a generally U-shaped form corresponding to the outline of the jaw of a user, the base member having an open frame structure with curved inner and outer elongate frame members interconnected at spaced intervals by transverse frame members, the base member having a central front region and left and right arm regions; and

a continuous teething engaging member made of a polymeric material that is a silicone rubber or polyvinyl chloride (PVC) that encloses and encases the base member and comprises a web and inner and outer flanges projecting up from an upper face of the web and defining an upper channel within which the upper arch and teeth of the user can be received.

The sports guard may include any one or more of the optional features of the orthodontic trainer defined in the preceding aspect of the invention.

Specifically the base member may be made of a polyamide material that is nylon. The teeth engaging member may be made of silicone rubber.

This invention also extends to a method of treating a patient to encourage improved oral habits and encouraging an improvement in the positioning of their teeth, the method comprising the steps of fitting an appliance as described in the first or second aspects of the invention above to a user, and getting the user to wear the appliance on a regular basis.

The wearer may wear the appliance for at least a few hours in each 24 hour day. Preferably the user wears the appliance at least a few hours during the day time and a few hours in the night time on each day.

This invention also extends to a method of protecting a user's teeth during the playing of sports and in particular contact sports, the method comprising the steps of fitting an appliance as described in the first or third aspects of the invention above to a user, and having the user wear the appliance when undergoing any activity that makes them susceptible to a blow to the head or jaw.

### DETAILED DESCRIPTION OF THE PREFERRED EMBODIMENTS

An oral appliance that is an orthodontic trainer or a sports guard in accordance with this invention may manifest itself in a variety of forms. It will be convenient to hereinafter provide a detailed description of some embodiments of the invention with reference to the accompanying drawings. The purpose of providing this detailed description is to instruct persons having an interest in the subject matter of the invention how to put the invention into practice. It is to be clearly understood however that the specific nature of this detailed description does not supersede the generality of the preceding statements. In the drawings:

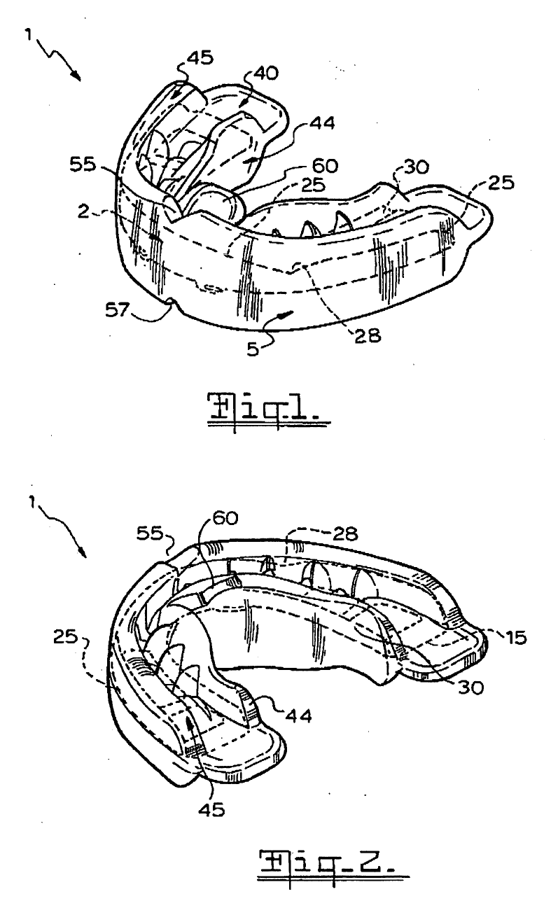

FIG. 1 is an upper front three dimensional view of an appliance that is an orthodontic trainer in accordance with the invention;

FIG. 2 is an upper rear three dimensional view of the appliance of FIG. 1;

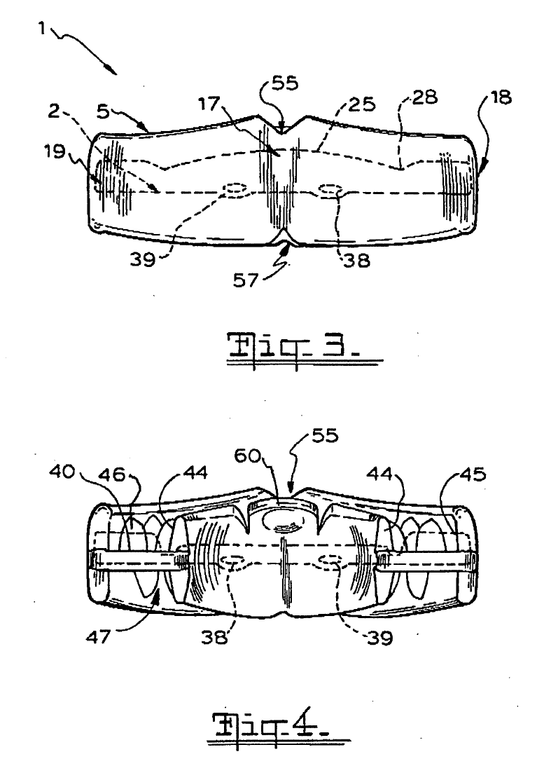

FIG. 3 is a front view of the appliance of FIG. 1;

FIG. 4 is a rear view of the appliance of FIG. 1;

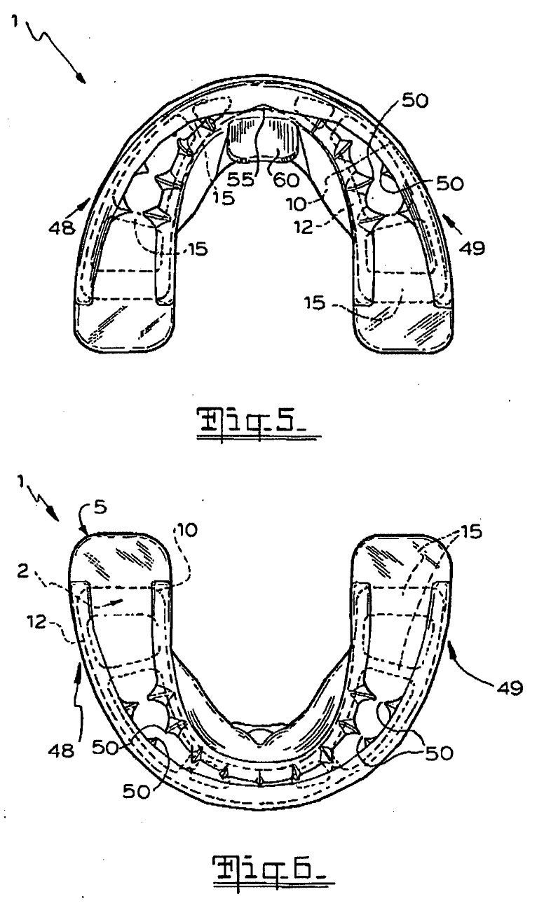

FIG. 5 is a top plan view of the appliance of FIG. 1;

FIG. 6 is a bottom plan view of the appliance of FIG. 1;

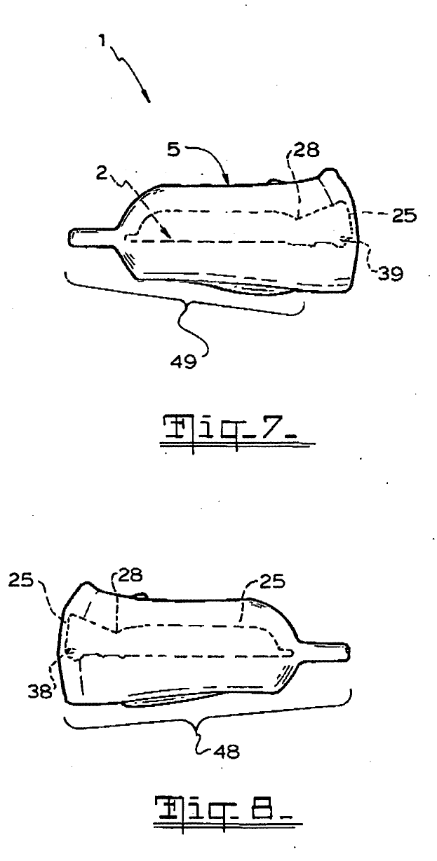

FIG. 7 is a side view of the appliance of FIG. 1 from one side;

FIG. 8 is a side view of the appliance of FIG. 1 from the other side;

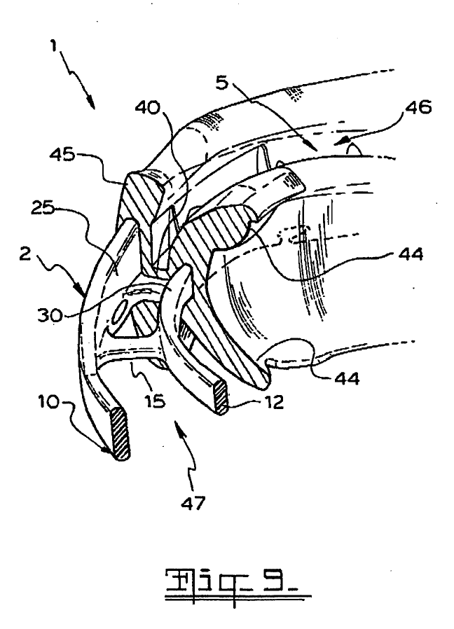

FIG. 9 is an upper three dimensional view of part of the appliance of FIG. 1 with part of the teeth engaging member removed to expose an underlying base member;

FIG. 10 is an upper three dimensional view of a base member for the appliance of FIG. 1; and

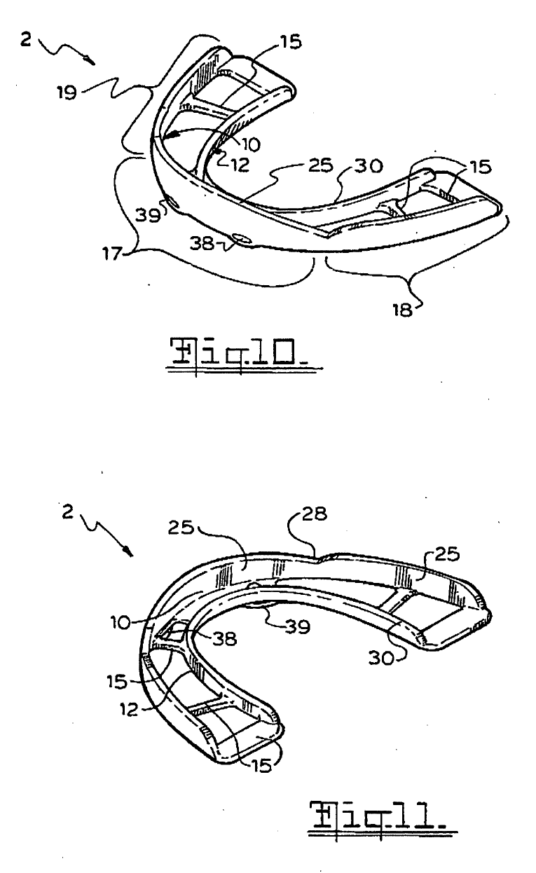

FIG. 11 is a lower three dimensional view of the base member of FIG. 10;

FIG. 12 is an upper three dimensional view of a sports guard in accordance with one embodiment of the invention not showing any hidden detail, viewed from the rear;

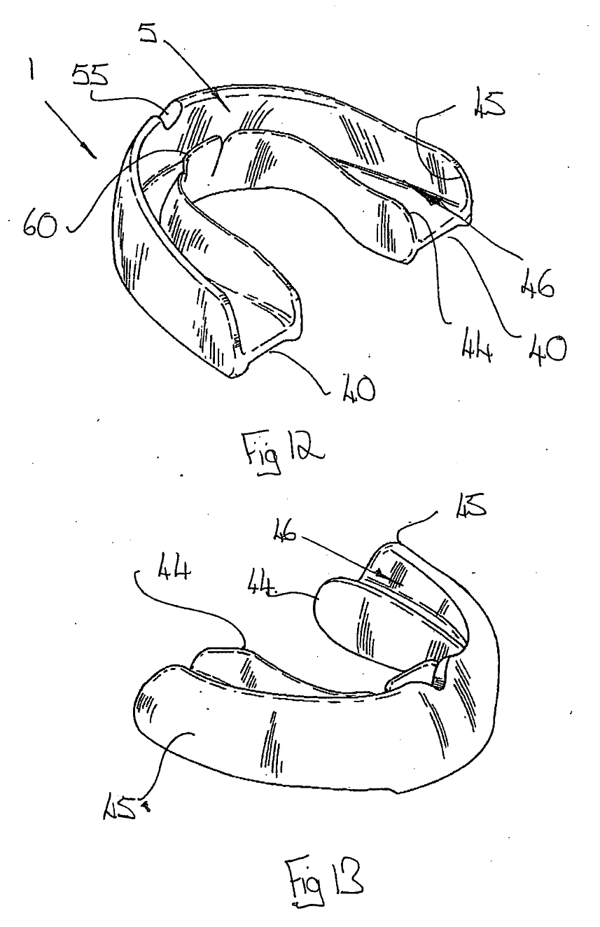

FIG. 13 is an upper three dimensional view of the guard of FIG. 12, viewed from the front;

FIG. 14 is a rear view of the guard of FIG. 12 showing the base member in hidden detail lines;

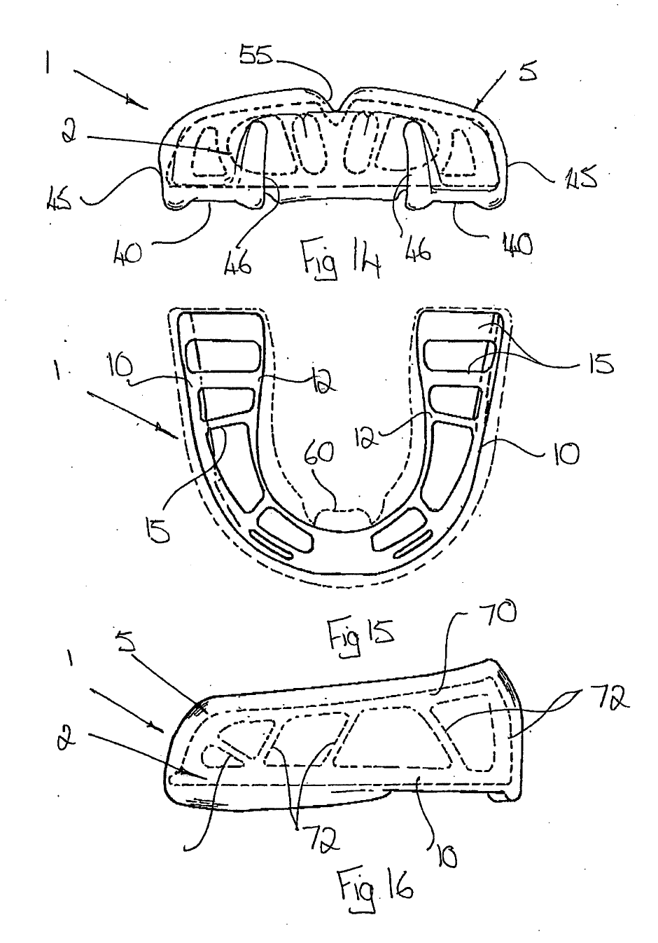

FIG. 15 is a bottom plan view of the guard of FIG. 12 showing the base member in hidden detail lines;

FIG. 16 is a side view of the guard of FIG. 12 showing the base member in hidden detail lines;

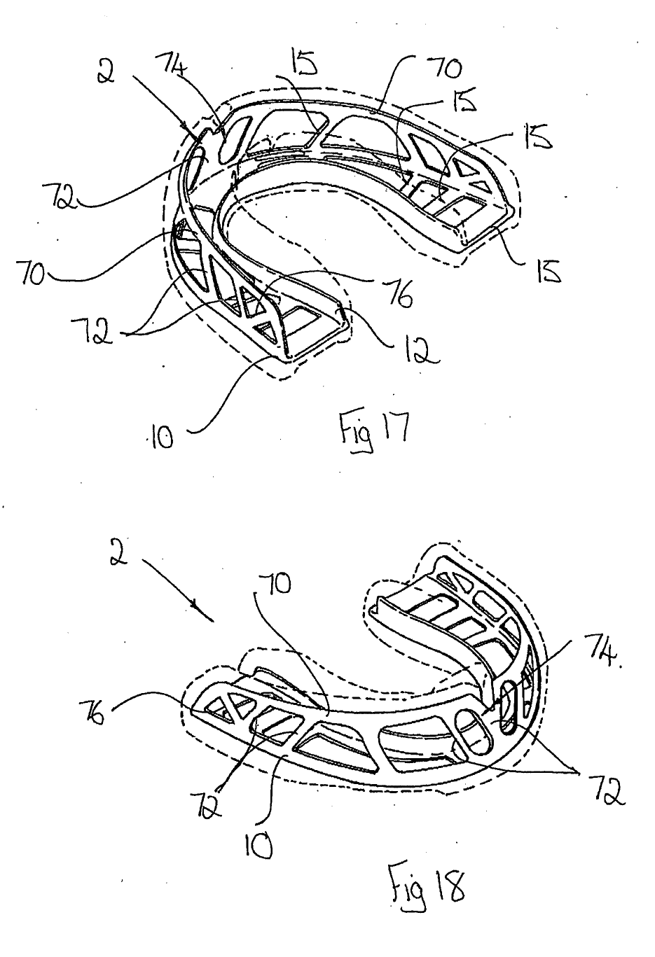

FIG. 17 is a rear upper three dimensional view of the base member of the guard of FIG. 12 also showing the teeth engaging member in dotted lines; and

FIG. 18 is a front upper three dimensional view of the base member of the guard of FIG. 12 also showing the teeth engaging member in dotted lines.

In FIGS. 1 to 9 reference numeral 1 refers generally to an appliance that is an orthodontic trainer in accordance with the invention.

The orthodontic trainer 1 comprises generally a base member 2 having a generally U-shaped form corresponding to the outline of the jaw of a user. The base member 2 which is shown in FIGS. 10 and 11 on its own is indicated by hidden detail lines in FIGS. 1 to 9. The orthodontic trainer 1 further includes a teeth engagement member 5 made of silicone rubber that encloses and encases the base member 2. The teeth engaging member 5 occupies a substantially greater volume than the base member 2 and forms the body and shape of the trainer 1. It also defines all the operative surfaces that interact with and engage the teeth and gum tissues of the mouth of a user.

The base member 2 is shown partially clearly in FIGS. 9 to 11 and has a base support in the form of an open frame structure with curved outer and inner longitudinal frame members 10 and 12 joined at spaced intervals by transverse frame members 15. The base member comprises a frontal portion indicated generally by numeral 17, and left and right arm regions indicated generally by numerals 18 and 19.

In the illustrated embodiment the base member 2 has several transverse frame members 15. One of these is located proximate to the front central region 17 of the circular elements 10, 12. This transverse frame member 15 has a width of about 8-12 mm and is considerably thicker than the other transverse frame members. The additional width serves to confer additional strength on this transverse frame member 15. Two further transverse frame members 15 are located adjacent the rear of the left and right trailing arm regions 18, 19 of the base member 2. These transverse frame members 15 have a width of 3-6 mm. While they are thinner than the front transverse frame member they are thicker than the remaining transverse frame members.

The remaining transverse frame members are known as intermediate transverse frame members 15. In the illustrated embodiment there are two said transverse frame members on each arm region 18, 19. The transverse frame members have a width of 1-4 mm, e.g. about 2 mm.

Further the base member 2 also includes an outer flange 25 projecting up from the curved outer frame member 10 and extending along the full length of the curved outer frame member 10. The outer flange 25 projects up above the transverse frame members 15 of the open frame structure and the general plane of the open frame (hereinafter called the outer flange).

The portion of the flange 25 in the front central region 17 of the outer curved frame member 10 projects further than that portion extending up from the left and right arm regions 18 and 19. The flange portion in the front central region 17 may have a maximum height of 6-8 mm. The flange portions on the left and right arm regions of the outer frame member 10 may have a maximum height of 5-7 mm.

The outer flange 25 defines a low point 28 on each side intermediate the central front portion 17 and the left and right hand arm regions 18, 19. The low point is positioned at the point where the eye teeth or canine teeth of a user are located. The reason for this is that the canine teeth are sometimes positioned laterally outward of the other teeth and if the flange was higher in this area the trainer might not fit over a user's teeth. Applicant has found that by reducing the height of the outer flange 25 at this point on each side the trainer can be fitted to most mouths without this problem occurring.

The curved inner frame member 12 of the base member 2 also has a flange 30 extending up from the open frame (hereinafter called the inner flange). The inner flange 30 projects up above the open frame a distance of 1-3 mm, e.g. about 2 mm. It is thus far less upstanding and prominent than the outer flange 25.

The curved outer and inner frame members 10, 12 and the outer and inner flanges 25 and 30 together apply a correcting force to any misaligned teeth in the upper and lower arches of a user and thereby actively promote correct positioning of the upper teeth. In addition it provides further rigidity or stiffness and structural strength to the base member 2.

The base member 2 in the drawings does not have a flange depending or extending down below the open frame of the base member 2 to any appreciable extent. Applicant has found that the upper flange provides the base member 2 with the necessary level of torsional rigidity and stiffness and a lower flange is not necessary. However it is to be clearly understood that a downwardly depending flange is considered to fall within the scope of this invention. For example, a downwardly depending flange would further increase the strength of the base member.

The base member 2 defines a pair of openings 38, 39 in its central front region 17. The openings 38, 39 are formed in both the inner and outer curved frame members 12, 10 of the base member 2. These are located on left and right sides of the front region 17 of the base member 2. The openings are formed by integral bracket or loop formations that depend down below the base member 2.

The openings 38, 39 cooperate with corresponding openings in the teeth engaging member 5 as will be described in more detail below.

The base member 2 is made of a rigid plastics material that does not melt or soften when exposed to temperatures below about 300° C. In the illustrated embodiment the base member is made of a polyamide material that is nylon. Nylon does not soften or melt when it comes into contact with molten silicone when the silicone is injection moulded onto the nylon. In addition it is hard and has been found to have an appropriate level of rigidity. At the same time it permits some movement of the left and right arm regions towards and away from each other and some twisting of the left and right arm regions relative to each other.

Nylon is a generic name of any long chain synthetic polymeric amide which has recurring amide groups as an integral part of the main polymer chain. The polymer is linear and as such is suited to being formed into a filament although this need not be the case. One of the properties of nylon that makes it suitable for this application is that it is capable of withstanding particularly high temperatures. As a result it does not soften or deform when it is brought into contact with molten silicon at high temperatures.

Applicant has obtained nylon from Shinko Chemical Company based in Taipei, Taiwan. The table below indicates the different grades of Nylon 66 supplied by this company.

| | | | | | | | |
|---|---|---|---|---|---|---|---|
| TENSILE | KG/cm² | 800 | 900 | 1700 | 1900 | 840 | 1150 |
| STRENGTH | | | | | | | |
| ELONGATION | % | 55 | 10 | 7.1 | 2 | 4 | 4.5 |
| FLEXURAL | KG/cm² | 1000 | 1350 | 2300 | 2600 | 1200 | 1700 |
| STRENGTH | | | | | | | |
| FLEXURAL | KG/cm² | 28000 | 35000 | 80000 | 108000 | 31000 | 72000 |
| MODULUS | | | | | | | |
| IZOD IMPACT | KG- | 13 | 8.5 | 11 | 9 | 7.3 | 7 |
| STRENGTH | cm/cm | | | | | | |
| ROCK WELL | R-SCALE | 118 | 119 | 120 | 120 | 118 | 119 |
| HARDNESS | | | | | | | |
| MELTING | ° C. | 260 | 260 | 255 | 260 | 260 | 260 |
| POINT | | | | | | | |
| M.D.T | ° C. | 66 | 200 | 238 | 240 | 73 | 248 |
| (18.6 KG/cm²) | | | | | | | |
| M.D.T | ° C. | 230 | 240 | 255 | 255 | 230 | 245 |
| (4.6 KG/cm²) | | | | | | | |
| ASH | W1% | . | 13 | 33 | 45 | — | 25 |
| CONTENT | | | | | | | |
| MOLD | | 1.7-1.8 | 0.3-0.5 | 0.2-0.4 | 0.2-0.3 | 1.0-1.3 | 0.3-0.5 |
| SHRINKAGE | | 1.3-1.4 | 0.8-1.0 | 0.7-1.0 | 0.3-0.5 | 0.7-1.0 | 0.7-1.0 |
| M.F. | g/10 min | 55 | 20 | 13 | 10 | 43 | 20 |
| SP Gr | g/cm² | 1.1 | 1.2 | 1.35 | 1.46 | 1.16 | 1.38 |

The Applicant has utilised a grade of Nylon 66 known as Nylon 66 6212GA for the appliances he has made. This material has the following properties:

| | |
|---|---|
| Tensile strength | 900 |
| Flexural Strength | 1350 |
| Rock Well Hardness | 119 |

Nylon can also be obtained from a number of other chemical suppliers including E I Du Pont Nemours Chemical Company (DuPont) based in Delaware in the USA. Applicant believes that nylon obtained from Du Pont will also work satisfactorily. This material is a staple commodity and could be obtained from a large number of nylon suppliers around the world. Applicant envisages that the invention would be able to be practised equally well no matter which supplier the nylon was sourced from.

The teeth engaging member 5 comprises a central web 40 that broadly surrounds and encases the open frame portion of the base member 2. It fills in the space between the cross elements 15 and also forms a layer of some thickness over the open frame. The teeth engaging member 5 also has inner and outer flanges 44, 45 extending both upwardly and downwardly both sides of the web 40. These flanges 44, 45 together with the web 40 form upper and lower channels 46, 47 within which the upper and lower teeth of a user are received. Like the base member 2 the teeth engaging member 5 may comprise a central front region and left and right arm regions 48 and 49.

The teeth engaging member is made of a polymeric compound containing silicon that is a silicone rubber that is of medical grade. This rubber is a staple commodity and can be bought from a number of well known chemical companies. For example, Applicant is aware that it can be bought from Du Pont Chemical Company based in Delaware in the USA.

Applicant has sourced a suitable silicone rubber from a Japanese chemical company by the name of Shin-Etsu Chemical Co Ltd based at 6-1, 2 Chome, Ohtemachi, Chiyodaku, Tokyo, Japan. The material specification data sheet provided by Shin-Etsu for this material is provided below.

MATERIAL SPECIFICATION DATA SHEET

| | | Transparent | | |
|---|---|---|---|---|
| SHIN-ETSU ® | | High Strength | | |
| TWO-COMPONENT | | KE-1950- | KE-1950- | KE-1950- |
| SILICONE RUBBER COMPOUND | | 50 | 60 | 70 |
| Typical Properties | Units | (A-B) | (A-B) | (A-B) |
| Viscosity in mPa · s | | 680 | 730 | 750 |
| (P) Brookfield-type rotational | | (6800) | (7300) | (7500) |
| viscometer | | | | |
| Specific Gravity at 25° C. | g/cm³ | 1.13 | 1.14 | 1.15 |
| (77° F.) | | | | |
| Mixing Ratio A:B | | 1:1 | 1:1 | 1:1 |
| Hardness JIS-A | | 50 | 58 | 68 |
| Tensile Strength JIS-6301 | Mpa | 9.3 | 7.8 | 7.8 |
| Elongation at break JIS-6301 | % | 55 | 380 | 350 |
| Tear Strength JIS-6301 | kN/m | 44.1 | 43.1 | 49 |
| Compression set 22 h/150° C. | (%) | 28 | 22 | 50 |
| Linear Shrinkage JIS-6301 | (%) | 2 | 1.9 | 2.1 |
| Volume Resistivity Comments | Ω-m | 10 T | 10 T | 10 T |

The grade of the silicone that the Applicant has used the most frequently for the appliance is KE-1950-70, which is the hardest grade.

Another supplier of silicone rubber is the Bayer Chemical Company based in Leverkusen, Germany. Bayer supplies a liquid silicone rubber LSR 2050 that is non toxic and suitable as a medical grade material. It is a two component rubber with each component packed in a separate container. These two components are then pumped into a static mixer and mixed thoroughly and then injected into the injection mould die.

The trainer also includes teeth positioning formations 50 in each of the inner and outer flanges 44, 45 of the teeth engaging member 5. The positioning formations 50 are for directing and biasing individual teeth into their correct position on the arch of the user.

Each said teeth positioning formation 50 comprises protrusions projecting out from each of the inner and outer flanges 44, 45 into the space defined by the upper and lower channels. Each of the protrusions of the teeth positioning formations 50 may be wedge shaped when viewed in cross section tapering inwardly from both sides to a point at the desired position between adjacent teeth.

Further there may be teeth positioning formations 50 in each of the upper and lower channels of the teeth engaging member 5.

In the illustrated embodiment there are teeth positioning formations 50 for locating the ten teeth of a user nearest the front of the arch on the upper jaw. Similarly the tooth engaging formations may also locate the ten forward teeth on the lower jaw of a user.

The orthodontic trainer may also include a notch or cut-out 55 in the midline upper surface of the outer flange 45 of the teeth engaging member 5. It also includes a smaller midline notch or cut-out 57 in the lower surface of the outer flange 45. The notches remove material from the teeth engaging member on the mid line so that it does not come into contact with soft tissue in this area. There is a tendon that extends across this area and It Is more comfortable for a user if the teeth engaging member 5 does not come into contact with this tendon.

The orthodontic trainer 1 also has a tongue tab 60 for positioning the tongue of a user in an exact central position. The tongue tab is formed in the inner flange 44 of the member 5 upwardly of the web 40. This assists in improving the oral habits of a user and particularly in avoiding tongue thrusting. The spaces on either side of the tab 60 perform the important function of permitting inward and outward adjustment of the arms of the trainer 1 to accommodate different arch sizes in different users. This enables two sizes of appliances with two different arch sizes to be capable of being fitted to most patients. There is also a small notch formed in the lower edge of the inner flange, eg in a central position.

Further the web 40 of the teeth engaging member 5, eg upper and lower faces thereof, tapers outwardly from the front region of the member 4 in a rear direction to the left and right trailing arm regions 48, 49. The effect of this is to progressively thicken the web 40 in a direction from the front to the rear of the teeth engaging member 5. This continues up to a point in the left and right trailing arm regions 48, 49 that is spaced forward of the rear ends of the arm regions. Thereafter the upper and lower faces of the engaging member 5 taper inwardly towards each other so as to progressively thin from said point to the rear of the teeth engaging member 5. In summary the web 40 can generally be described as having an asymmetric aerofoil shape on each arm region 48, 49 extending back from the front region. The aerofoil has a curved surface on its lower side and thus can be thought of as being inverted.

This aerofoil shape of the web 40 fills in the space between the upper and lower teeth of a user and supports the jaw. This enables the bottom jaw to assume its anatomically correct position in relation to the upper jaw and this has relaxation and muscular benefits to the user.

The teeth engaging member 5 also has passages defined therein in the same place as the apertures 38, 39 of the base member 2. These passages are continuous and open at both ends. The openings 38 and 39 in the base member increases the surface area of the teeth engaging member 5 in contact with the base member 2. This is advantageous because it also assists in holding the teeth engaging member on the base member and resisting delamination.

The orthodontic trainer is manufactured as follows. First the base member 2 is injection moulded from nylon in a first injection moulding step. The teeth engaging member 5 is then moulded around and over the base member 2 and encases the base member 2 in a second moulding step. The formed orthodontic trainer 1 can then be removed from the die.

The cycle times for each of the moulding steps may be about 15 seconds. The cycle time for the silicone rubber moulding will be longer than that for the nylon base member. Generally the moulded pieces are allowed to cool passively. However the silicone rubber can be actively cooled once it has been moulded. Generally the members are removed from the die once the moulded material has had an opportunity to cool sufficiently.

The molten silicone is introduced to the die at a very high temperature, eg at least 300° C. Therefore the moulded base member has to be able to withstand this temperature without softening. Nylon is capable of withstanding the temperatures of injection of the silicone and thus has been found to be very suitable for this purpose. Further nylon has a high level of stiffness and local hardness while at the same time permitting some flexing of the arm regions of the trainer towards and away from each other.

The trainer may be moulded in two separate dies with the base member being moulded in a first die then being removed and placed in a second die where the teeth engaging member is moulded.

Alternatively the base member and the teeth engaging member may be moulded in the same mould in a co-injection process. That is the base member is moulded in a first step by an injection moulding process and then subsequent thereto the teeth engaging member is moulded onto the base member by a second moulding step. The base member does not have to be removed from the mould before the teeth engaging member is moulded onto it. The mould comprises two mould parts, one for each of the base member and the teeth engaging member, that are brought in sequence into operative positions in the moulding area.

In use the orthodontic trainer described above will typically be fitted by an orthodontist or a dentist. The trainers envisaged by the Applicant will have at least two different sizes of base member. Each of these sizes of base member will then have at least four different sizes of teeth engaging member with different sizes of teeth locating formations.

Accordingly the first step of the practitioner will be to choose an appropriate trainer from the different sizes of trainers and insert it into a patient's mouth. Generally a practitioner will choose a size of trainer after inspecting and measuring the arch and teeth of the user. However a trial and error procedure could also be used whereby the practitioner tried each of the different sizes of appliance and then selected the one that fitted the best.

Once fitted to the patient's mouth the soft silicone rubber of the teeth engaging member bears against the gum and teeth of the user. The skeletal base member provides the underlying strength to preserve the shape and form of the arch defined by the trainer and also urges the teeth into a desired position.

The inner and outer flanges of the teeth engaging member bear against the teeth. While the silicone is soft and has some ability to conform to the mouth of a user it is also resilient and thus when it is deformed by the teeth it applies a return force against the teeth of the user. This force tends to align individual teeth so that they do not protrude or retract. The underlying rigidity of the base member maintains the shape of the arch so that it forms a smooth curved or parabolic shape when viewed in plan view. Thus a narrow arch on a user is urged to widen by the resilient biasing force of the deformed base member. This is analogous to active spring energy. The biasing force is applied against the teeth tending to widen out the arch. The teeth positioning formations also encourage the individual teeth to take up their preferred position by along the length of the line of the arch. The application of force to move teeth is standard practice in orthodontics.

The orthodontic trainer receives both the upper and lower arches and teeth of a user and thus is not suitable for use during every day living. For example a user could not talk or eat while they were wearing the trainer. The trainer will typically be worn by a user for a few hours each night. It is also advantageous if the trainer is also worn for a few hours in the day time when this is possible. Over time through the application of force to the appropriate face of the teeth it will tend to move the teeth towards their desired positions. The physiological mechanism by which tooth movement is accomplished is well understood by the dental and orthodontic community and will not be described in this specification.

In another embodiment of the invention that has not been illustrated in the drawings the base member is made out of nylon and the teeth engaging member is made of polyvinylchloride (PVC).

PVC resin is a staple commodity in the chemical industry and is available from a large number of chemical manufacturers around the world. Applicant has obtained PVC resin from IMPRODEX which is a division of Pacific Dunlop Limited based at 135 Racecourse Road, Flemington, VIC, Australia.

The specification for the product used by the Applicant is HYCO 4016-89 PVC compound. This is a clear extrusion grade PVC compound for applications requiring good clarity and low toxicity and is suitable for food contact use.

The properties of this PVC grade are as follows:

SPECIAL PROPERTIES

| | |
|---|---|
| Shore A Hardness (ASTM 2240) Instantaneous | 79 |
| Shore A Hardness (ASTM 2240) 10 second delay | 71 |
| Specific Gravity | 1.22 |
| Tensile Strength | 17.7 MPa |
| Elongation at Break | 400% |

A trainer made of these materials and having the same structural features and form as the silicone rubber trainer described above is manufactured by a similar two step moulding process. The base member is moulded of nylon in a first step. Thereafter the teeth engaging member is manufactured of PVC in a second injection moulding step.

An advantage of using PVC instead of silicone rubber is that it does not require as high an injection temperature. This simplifies the moulding equipment that is used. It also reduces the temperature that the base member is required to withstand when the teeth engaging member is moulded onto it. This then opens up the possibility of using materials other than nylon for the base member. Applicant envisages that other materials such as addition polymers, eg such as polyethylene, and polypropylene, and condensation polymers such as polyurethane and polycarbonate and a thermoplastic elastomer such as santoprene may be used. Further other thermoplastic material may also be suitable.

In use this trainer is used in the same way as the trainer described above. The PVC has similar properties to silicone and the other polymeric materials if they are used have similar properties in use as the nylon.

FIGS. 12 to 18 illustrate an appliance that is a sports guard in accordance with the invention.

The sports guard is structurally and functionally similar to the trainer described above with reference to FIGS. 1 to 11. Accordingly unless otherwise indicated the same reference numerals will be used to refer to the same components.

The first significant difference between this embodiment and the trainer is that the guard only has an upper channel for receiving the upper arch and teeth of a user. It does not have a lower channel for receiving the lower teeth of a user.

The base member 2 comprises an open frame assembly as with the trainer Illustrated in FIGS. 1 to 11.

However while the open frame assembly in FIGS. 1 to 11 was mainly planar the open frame assembly in FIGS. 12 to 18 is more elaborate and extends upwardly as well as in a horizontal plane.

The open frame comprises a lower outer curved longitudinal frame member 10 as in FIG. 1 and also an inner curved longitudinal frame member 12 spaced inwardly from the outer member 10. Both the inner and outer members 12, 10 can be said to lie on the same horizontal plane and form a horizontal frame portion.

The inner and lower outer frame members 12, 10 are interconnected by transverse frame members 15 that are also lying in the same horizontal plane as the inner and outer members 12, 10. These transverse members 15 are located at spaced intervals along the length of the inner and lower outer members 12, 10. There are particularly prominent transverse members 15 in the front central region 17 and also at the rear of the trailing arm regions 18, 19.

The base member in FIGS. 14 to 18 also includes an upper outer curved longitudinal frame member 70. This upper longitudinal frame member 70 is positioned spaced above the lower longitudinal frame member 10. It is of similar thickness and dimensions as the lower outer longitudinal frame member 10. The frame members 10, 70 together define a vertical frame portion. The upper member 70 is spaced about 7-14 mm, e.g. 8-12 mm, above the lower member 10.

The base member 2 further includes vertically extending transverse frame members 72 extending between the upper and lower outer longitudinal members 70, 10 at spaced intervals along the lengths of these members 70, 10 and the length of the base member 2 generally.

A prominent vertical transverse member 72 is positioned in the central front region 17 of the base member 2. This transverse frame member 72 has a bifurcation 74 towards its upper end. This bifurcation 74 has the purpose of detouring around the cut 55 in the outer flange 45 of the teeth engaging member 5. The cut 55 is described above with reference to FIG. 1.

Further prominent vertical transverse frame members 72 are located towards the rear of the upper and lower outer frame members 70, 10. In addition there are some intermediate vertical transverse members 72 in between these prominent transverse frame members in the front region and at the rear.

The intermediate transverse frame members 72 towards the front of the base member 2 may incline or extend diagonally rearward from bottom to top. By contrast some of the transverse frame members towards the rear may be inclined forwardly from bottom to top. A strut or cross brace 76 may extend diagonally up and rearward from the lower member 10 to the point of intersection of the rear transverse member 72 with the rear of the upper longitudinal member 70. This helps to absorb force transmitted through the base member in a rearward direction from a blow applied to the front of the guard.

By contrast there is no equivalent vertical open frame structure extending up from the inner longitudinal frame member.

As shown in the drawings the inner longitudinal frame member 12 is thickened somewhat along its full length so that it projects up above the horizontal transverse frame members 15. This is shown particularly clearly in FIGS. 17 and 18. The illustrated inner frame member 12 has a height of about 2 to 10 mm, e.g. 3-7 mm.

However it does not have an open frame structure extending up from it like the outer frame member 10.

The open frame structure permits some resilience which absorbs energy. The purpose of having the vertical frame portion with upper outer frame member 70 and transverse members 72 and brace 76, in addition to the horizontally extending portion of the open frame, is to further strengthen the base member. In particular this vertically extending portion of the open frame positioned as it is over the outside of the teeth strengthens the guard against frontal impacts it thus protects the upper teeth and particularly the incisors on the upper arch against damage due to frontal impacts.

The base member in the illustrated guard is made of a polyamide material such as nylon.

The teeth engaging member 5 is characterised by the fact that the inner and outer flanges only define an upper channel within which the upper arch and upper teeth are received. The underside of the guard is substantially flat as shown in FIGS. 14 and 16. This can make contact with the tops of the lower row of teeth of a user in use but does not receive them. When a user's mouth is closed the underside may rest on the lower row of teeth. This enables a user to speak while they are wearing the guard and also enables them to breathe heavily. Many sports guards have this general characteristic.

The teeth engaging member 5 encases and receive the base member 2. As shown in the drawings the thickness of teeth engaging material covering the base member is fairly generous. This causes the outer surface of the teeth engaging member to be suitably soft to a user. It also increases the protection afforded by the guard.

The teeth engaging member does not have teeth positioning formations like those in the FIG. 1 embodiment. This is because its sole function is to protect the teeth and jaw and not to reposition the teeth.

The teeth engaging member in the illustrated guard is made of silicone rubber. The silicone rubber is moulded onto the polyamide base member. The silicone rubber is favoured for teeth engaging member because of its softness and the fact that its use is already accepted in oral appliances.

In use as a sports guard the guard is initially fitted by a dentist or any other person in much the same way as the orthodontic trainer described above. An appropriately sized guard is selected from the different sizes that are available and this is inserted into the mouth of a user.

Thereafter the guard is worn by the user as required during the playing of contact sports. Significantly the guard does not need to be placed in boiling water and then moulded to suit the mouth of a user.

The guard has considerable strength notwithstanding the fact that the silicone rubber is soft. This is due to the strength of the nylon base member underneath the silicone teeth engaging layer. The base member with the vertical frame portion across the front region thereof causes any frontal blow to be applied across the full arch of the jaw and not just across the front teeth.

The guard described above will find particular application with children, particularly those that are still growing. Children have shown some resistance to using guards that need to be moulded and would prefer a guard does not need to be moulded.

The nylon provides sufficient resilience and spring force to enable the appliance to be fitted to most user's with some degree of comfort without any moulding being carried out. Further the softness of the silicone rubber also assists the guard to be fitted to a user with a reasonable degree of comfort notwithstanding that it has not been moulded.

The appliance thus has provided to be very efficacious in use as a sports guard. In particular the guard has been found to provide a reasonably high level of protection to the teeth and jaws of a user. It is particularly suitable for growing children where the force of any blow will be less than when adults are playing the sport. It is also particularly suitable for low level contact sports where the likely intensity of any blow suffered will be less than in rugby or gridiron. The sports guard is particularly suitable for use in sports such as soccer, squash and hockey.

An advantage of the appliance described above with reference to the drawings is that it can apply a force that is strong enough to widen the arch and reposition teeth. The force that is applied to the teeth is comparable to that achieved by other orthodontic appliances. The repositioning force is due to the underlying strength of the nylon base member. The base member has the effect of applying a force to misaligned teeth, be it protruding or retracting, and this force tends to return them to the arch form or the arch line.

The flange on the outer curved frame member of the base member assists with the realignment of teeth and widening of the arch of the user. The inner and outer longitudinal frame members of the base member including the flanges have the effect of pushing the teeth forward when they are retruded or misaligned. Similarly if the tooth is rotated, with the distal edge protruding and the mesial edge retruded, then the inner and outer flanges also apply a force to encourage rotational realignment to the correct position. Yet further if the arch form is narrow, the inner and outer frame members are designed with a wide arch form and are resilient, and thus urge the teeth outwardly to widen the arch form.

Thus the trainer does not simply align adjacent teeth with each other so that they do not protrude. Rather it tends to widen the arch if it is narrower than the ideal arch width. It also correctly positions the individual teeth at the correct point along the line of the arch. This way the line between the two front teeth is positioned on a mid-line of the arch. This is an important requirement for satisfactory cosmetic orthodontics.

A further advantage of the orthodontic trainer described above is that the silicone rubber is a very soft material. It therefore has the ability to conform to the contours of a user's teeth and gums without applying too much local pressure to the teeth and gums. As such the trainer is not unduly harsh on a user's mouth. It does not tend to injure the soft tissues in a patient's mouth and also can be worn with a reasonable degree of comfort.

Yet further the trainer can be manufactured in a moulding operation in large quantities. The appliance is injection moulded in a two step moulding operation. This will enable it to be produced at reasonable cost. It does not need to be custom moulded for each individual user. This enables it to be supplied to the market at a reasonable cost.

A further advantage of the orthodontic trainer described above is that it has locating formations for positioning individual teeth of a user in an optimum position. This positioning of individual teeth on the parabolic curve of the arch with a mass manufactured trainer is a significant advance.

Yet further the orthodontic trainer has a tab for correctly positioning the tongue and spaces on either side of the tab to permit the arms of the trainer to be opened or closed to some extent.

An advantage of the sports guard described above is that it enables an efficacious sports guard to be provided that is capable of fitting to most users. Further the sports guard is comfortable because the silicone rubber that makes contact with the teeth and gums of a user is soft and conformable. Further the sports guard provides an efficacious amount of protection against blows to the head and mouth during the playing of sports. Further this sports guard can be provided to the market at a very reasonable cost and it does not require moulding in boiling water before it is fitted to a user.

It will of course be realised that the above has been given only by way of illustrative example of the invention and that all such modifications and variations thereto as would be apparent to persons skilled in the art are deemed to fall within the broad scope and ambit of the invention as herein set forth.

1. An oral appliance, comprising:
a base member having a generally U-shaped form corresponding to the outline of the jaw of a user, the base member being made of a material; and
a continuous teething engaging member made of a material that is softer than the material of the base member that encloses and encases at least part of the base member and defines at least one of upper and lower teeth channels within which the associated arch and teeth of the user can be received.

2. An oral appliance according to claim 1, wherein the teeth engaging member is made of a polymeric material.

3. An oral appliance according to claim 2, wherein the polymeric material of the teeth engaging member is silicone rubber.

4. An oral appliance according to claim 2, wherein the polymeric material of the teeth engaging member is an addition polymer which is polyvinyl chloride (PVC).

5. An oral appliance according to claim 1, wherein the base member is made of a polymeric material that is resilient.

6. An oral appliance according to claim 5, wherein the polymeric material from which the base member is formed is a polyamide material that is formed either by a condensation polymerisation of amide monomers or a ring opening polymerisation of caprolactam.

7. An oral appliance according to claim 6, wherein the polymeric material of the base member is an addition polymer including polyethylene or polypropylene or a condensation polymer including polyurethane or polycarbonate or a thermoplastic elastomer that is santoprene.

8. An oral appliance according to claim 7, wherein the base member is made of polyamide material and the teeth engaging member is made of silicone rubber.

9. An oral appliance according to claim 1, wherein the base member is in the form of an open frame structure.

10. An oral appliance according to claim 9, wherein the open frame structure comprises curved inner and outer longitudinal frame members that are interconnected at spaced intervals by transverse frame members and wherein the longitudinal frame members and the transverse frame members may all lie broadly in the same plane.

11. An oral appliance according to claim 10, wherein the base member further includes an outer teeth repositioning formation on the outer longitudinal frame member.

12. An oral appliance according to claim 11, wherein the outer teeth repositioning formation comprises an outer flange projecting up from the outer longitudinal frame member above the height of the transverse frame members.

13. An oral appliance according to claim 12, wherein the base member has a central front region and left and right arm regions extending rearward from the central front region to left and right rear ends.

14. An oral appliance according to claim 13, wherein the outer flange projects upwardly from the transverse frame members along at least said central front region whereby to extend over and across the upper front teeth of a user in use.

15. An oral appliance according to claim 14, wherein the central front region of the outer flange extends upwardly above an upper surface of the transverse frame members by 2-10 mm.

16. An oral appliance according to claim 14, wherein the outer flange also projects upwardly above the transverse frame members along left and right arm regions of the base member.

17. An oral appliance according to claim 16, wherein the left and right arm regions of the outer flange extend upwardly above the transverse frame members of the open frame by 2-6 mm whereby to extend over at least part of the molars of the user in use.

18. An oral appliance according to claim 16, wherein the outer flange is interrupted or of reduced height at positions on the left side intermediate the left arm region and the central front region of the outer flange, and also on the right side intermediate the right arm region and the central front region of the outer flange, said positions on the left and right sides corresponding to the positions of the canine teeth of a user.

19. An oral appliance according to claim 12, wherein the outer flange is formed integrally with the curved outer longitudinal frame member.

20. An oral appliance according to claim 11, wherein the base member further includes an inner teeth repositioning formation on the inner longitudinal frame member.

21. An oral appliance according to claim 20, wherein the inner teeth repositioning formation comprises an inner flange projecting up from the inner frame member above the height of the transverse frame members.

22. An oral appliance according to claim 21, wherein the inner flange on the curved inner longitudinal frame member extends a distance of about 1-3 mm away from an upper surface of the transverse frame members.

23. An oral appliance according to claim 21, wherein the inner flange projects up from the transverse frame members along the full length of the inner longitudinal frame member and the inner flange projects up substantially the same height along its full length.

24. An oral appliance according to claim 21, wherein the inner flange is formed integrally with the curved inner element.

25. An oral appliance according to claim 9, wherein the base member has a front said transverse frame member in the central front region of the base member, and also rear said transverse frame members towards the rear of the left and right arm regions of the base member.

26. An oral appliance according to claim 25, wherein the base member further includes intermediate transverse frame members in between the rear transverse frame members at the rear of the arm regions and the front transverse frame member.

27. An oral appliance according to claim 26, wherein the transverse cross element in the central front region of the base member has a width of 5-15 mm, and the rear transverse cross elements at the rear of each of the arms have a width of 2-10 mm, and the intermediate transverse frame members have a width of 1-4 mm.

28. An oral appliance according to claim 1, wherein the teeth engaging member comprises a central web having upper and lower surfaces that extends parallel to the plane of the open frame, and also inner and outer flanges that project transversely away from at least one of the upper and lower surfaces of the web and define with the web at least one channel within which the teeth of a user are received.

29. An oral appliance according to claim 28, wherein the open frame structure has upper and lower faces and inner and outer sides, and the teeth engaging member encases the upper and lower faces of the open frame structure and also the inner and outer sides of the open frame structure.

30. An oral appliance according to claim 29, wherein the teeth engaging member includes flanges that project away from both the upper and lower surfaces of the web defining both upper and lower channels within which respectively the upper and lower rows of teeth of a user can be received.

31. An oral appliance according to claim 30, wherein the teeth engaging member extends fully around and over the base member and completely encases the full surface of the base member.

32. An oral appliance according to claim 31, wherein the teeth engaging member covers an outer surface of the outer flange with a layer of material that is substantially thinner the layer of material covering an inside surface of the outer flange whereby to assist in holding the base member and teeth engaging member together.

33. An oral appliance according claim 29, wherein the teeth engaging member further includes one or more teeth positioning formations in at least one of the channels, each said positioning formation assisting in positioning the teeth of a user that are adjacent to it in use.

34. An oral appliance according to claim 33, wherein the teeth engaging member includes a plurality of teeth positioning formations, said plurality of teeth positioning formations collectively positioning at least the central front two incisors of the teeth of a user.

35. An oral appliance according to claim 34, wherein said plurality of teeth positioning formations collectively position the front four teeth of a user and also the three teeth on each side rearward of the front four teeth of a user on both the upper and lower rows of teeth of a user.

36. An oral appliance according to claim 33, wherein each teeth positioning formation comprises a wedge shaped protrusion extending inwardly from a said flange into a said channel, and wherein the wedge shaped protrusions are integrally moulded with the teeth engaging member.

37. An oral appliance according to claim 1, further including at least one breathing hole passing there through, and a tongue tab for encouraging a user to correctly position their tongue, and also a cut away on the curved outer flange of the teeth engaging member both above and below the web so that in use the soft gum of a user in this region does not make contact with the teeth engaging member.

38. An orthodontic trainer, comprising:
a base member made of polyamide material having a generally U-shaped form corresponding to the outline of the jaw of a user, the base member having an open frame structure with curved inner and outer elongate frame members interconnected at spaced intervals by transverse frame members, the base member having a central front region and left and right arm regions, and the base member including a teeth repositioning formation on the outer elongate frame member that extends across at least the front central region; and
a continuous teething engaging member made of silicone rubber or PVC that encloses and encases the base member and comprises a web and inner and outer flanges projecting up and down from both upper and lower faces of the web and defining upper and lower channels within which the upper and lower teeth of the user can be received.

39. An orthodontic trainer according to claim 38, wherein the teeth repositioning formation on the outer elongate frame member also extends across at least part of the left and right arm regions as well as said central front region.

40. An orthodontic trainer according to claim 38, wherein the base member includes a further teeth repositioning formation on the inner elongate frame member.

41. An orthodontic trainer according to claim 38, further including teeth positioning formations for encouraging the correct positioning of the teeth of a user.

42. An orthodontic trainer according to claim 38, wherein the teeth engaging member is made of silicone rubber.

43. A sports guard, comprising:
a base member made of nylon having a generally U-shaped form corresponding to the outline of the jaw of a user, the base member having an open frame structure with curved inner and outer elongate frame members interconnected at spaced intervals by transverse frame members, the base member having a central front region and left and right arm regions; and
a continuous teething engaging member made of silicone rubber or PVC that encloses and encases the base member and comprises a web and inner and outer flanges projecting up from the upper faces of the web and defining an upper channel within which the upper arch and teeth of the user can be received.

44. A method of treating a patient to encourage improved oral habits and encouraging an improvement in the positioning of their teeth, the method comprising the steps of fitting an appliance in accordance with claim 1 to a user, and getting the user to wear the appliance.

45. A method of treating a patient according to claim 44, wherein the user wears the appliance for at least a few hours a day and does this at least three days a week.
